(19) United States
(12) Patent Application Publication
(10) Pub. No.: US 2012/0297344 A1
(43) Pub. Date: Nov. 22, 2012

(54) SEARCH AND BROWSE HYBRID

(75) Inventors: Tira Cohene, Seattle, WA (US); Rolf Ebeling, Kirkland, WA (US); Priya Vaidyanathan, Clyde Hill, WA (US)

(73) Assignee: MICROSOFT CORPORATION, Redmond, WA (US)

(21) Appl. No.: 13/113,065

(22) Filed: May 22, 2011

(51) Int. Cl. G06F 3/048

(52) U.S. Cl. 715/843

(57) ABSTRACT

A unified search and browse experience may be provided by combining filters that are based on folder location with filters that are based on search criteria. In one example, a user opens a file explorer program and is presented with an initial set of filters. Some of the filters may be folder names, and other filters may be search queries. The user chooses a filter, and then continues to refine the set of files that he or she is looking for by successively selecting new filters and/or typing new filters free-form. The new filters may be folder names or search criteria. The system may suggest new filters based on analysis of files and/or past user behavior. A filter chain records the user's history of having added filters, and the user may add, delete, or replace filters in the chain.

### BACKGROUND

Two basic ways of looking for files on a computer or other device are browsing and searching. Browsing involves looking through folders and sub-folders for a file. Searching involves entering a query that contains some detail that the user has recalled about the file, such as a term within the file, a part of the file's name, some metadata associated with the file, etc.

Mechanisms for allowing users to find files generally focus on either the browse experience or the search experience. That is, in a browse-based experience the user can typically drill down through the hierarchy of folders to find the file based on some recollection about where the file is located. A search-based experience, on the other hand, largely ignores the hierarchical organization of files, and instead attempts to find the file based on a query containing some information that the user recollects about the file.

### SUMMARY

Searching and browsing for files may be combined into a unified experience. In order to unify the experience of searching and browsing, search queries and file locations may each be treated as a kind of filtering criteria. Thus, when a user first starts to look for a file, the user may be presented with various different types of filtering criteria, such as “photos”, “.mp3”, “New York folder”, “modified in the current year”, etc. In this case, “photos” is a broad category of files (e.g., JPEGs for which the capture device is a camera), “.mp3” is a specific file type, “New York folder” is an identification of a specific folder location in the directory structure, “modified in the current year” is a logical criterion whose truth can be evaluated against each file's date-and-time metadata. While many systems treat folder location as being a different type of criteria from search queries or metadata values, a unified search-and-browse experience may treat all of these criteria as being simply different types of filters. Thus, there is nothing exceptional about the criterion of a file being in the “New York folder”; it is effectively just another filter that can be applied.

When a filtering criterion has been selected, files that satisfy the filtering criteria may be shown to the user. The user may select additional filtering criteria, which may be based on folder location, or may be based on other types of search criteria. A system may suggest further filtering criteria based on the criteria that have already been selected and/or based on the user's history of usage. For example, if the user has selected “photos” as a criterion, the system may propose additional criteria such as “ISO 800”, “New York trip photos folder”, or any other type of criteria that narrows the photo selection. These further criteria might be offered based on the system's analysis of what type of files appear with the photo filtering criteria (e.g., it may have noticed that many of those files are in the “New York trip photos” folder). Or, the further criteria might be offered based on the user's history of usage (e.g., there might be a record that when the user has selected “photos” as a criteria, the user often has subsequently selected “New York trip photos folder” as the next criterion, so the system might infer that the user is likely to make that selection again).

The system may collect the various filtering criteria in a chain (e.g., “photos->New York trip photos folder->ISO 800->year 2010-> . . . ”), and may allow a user to remove and/or add criteria at any point in the chain. For example, the user might remove “ISO 800” as a criteria, thereby causing the chain to become “photos->New York trip photos folder->year 2010-> . . . ”, without removing the criteria (e.g., “year 2010”) that appear in the chain after the removed criterion. The user could also add criteria to the chain either at the end of the chain or at an intermediate point.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example user interface showing files that have been found using a combined search and browse experience.

FIGS. 2 and 3 are block diagrams of examples in which filters are replaced and deleted, respectively.

FIG. 4 is a flow diagram of an example process of providing a unified browse and search experience to a user.

FIG. 5 is a flow diagram of an example process of removing and replacing a filter.

FIG. 6 is a block diagram of example components that may be used in connection with implementations of the subject matter described herein.

### DETAILED DESCRIPTION

When searching for files, users are often given a choice of two general methods: browsing and searching. With browsing, the user navigates through folders and sub-folders, and attempts to find a file based on the file's location. Browsing works when files have been organized in some manner, and when the user recalls something about the location of the file. With searching, the user enters some type of search criterion—e.g., a term contained in the file, the date associated with the file, the type of file, some constraint on the metadata associated with the file, or some other piece of information about the file. A search engine then attempts to find the file based on that criterion. Searching works when the user recalls some detail about the file that can be used as a search criterion. While some systems may allow for some interplay between searching and browsing, in general search and browse techniques are performed separately, and the user chooses either searching or browsing as the method that he or she will use to find a file. However, in some cases a user may want to find files in a way that combines aspects of searching and browsing.

The subject matter described herein provides a unified experience that combines aspects of both searching and browsing. In order to combine these aspects, a system that implements the subject matter may allow a user to find a file based on filtering criteria, which the user can apply in layers in order to further narrow what he or she is looking for. When such filtering criteria are used, the location of a file (i.e., what folder the file is located in) and a search query are treated as just two different types of filtering criteria. A user's quest to find a file can combine both query-based and location-based filtering criteria into a single experience. Moreover, the system can suggest additional filtering criteria that are query-based and location-based.

When a user begins to look for a file, the system that assists users in finding files (e.g., a file explorer program) may show the user various options of things to search for. Examples of such options include applications, documents, pictures, music, videos, mail, or other categories. In one example, the system may show previews of the various categories—e.g., if “music” is one of the categories, then the system might show a preview box that contains a few (but not all) of the music items. Moreover, in one example, the system might show previews in different sizes based on the presumed relevance of a particular category and/or the likelihood that the user will pick that category—e.g., if the system believes that the user is more likely to search for “music” than “mail”, then the box that represents the music preview might be shown larger than the mail preview. It is noted that some of the suggested categories might correspond to particular folders on the user's computer, while others might not. For example, “documents” might refer to a category of files (e.g., all word processing and spreadsheet documents) that are stored in various different folders, while “music” might refer to files that are aggregated under a specific folder named “music” (although the music files might be found in sub-folders that are inside the main “music” folder).

Once the user chooses a category, the system might show a window that contains some type of list of the files that satisfy that category. This list could take any form, such as a textual list or a set of icons. The system may also show suggestions for further filters. For example, if the user chooses “pictures” as the initial filter, the system might determine that the various folders in which pictures are concentrated are named “New York trip”, “graduation”, and “picnic”, and might offer these folders as filters. The system might also determine that many pictures are tagged with the digital “film speed” (“ISO”) at which the pictures were taken, so the system might offer categories such as “ISO 200”, “ISO 400”, “ISO 800”, etc., as further filters, even though these categories might not correspond to particular folders. Any location-based or query-based criterion could be offered as a filter (where a criterion that is based on the value of a tag—such as “ISO 200”—is an example of a query-based filter). The particular filters that are to be suggested might be based on an analysis of files (as in the case where the system determines that photos tend to concentrate in the “New York trip”, “graduation”, and “picnic” folders), or might be based on history of usage patterns (e.g., the system might offer a filter such as “file's year is the current year” if the user has frequently specified such a filter in the past). While the system might suggest filters (both as initial filters, and as additional filters to be applied after some filters have been selected), it is noted that the user has the option of specifying his or her own filters irrespective of the suggestions. For example, the user can simply type a query or the name of a folder to be used as a filter, even if the query or folder name was not suggested by the system.

When a set of filters has accumulated, the user interface (UI) through which the system communicates information to the user might show the filters as a chain. For example, if the user has selected the filters “pictures”, “New York folder”, and “ISO 800” in that order, then the UI might contain the text “Pictures->New York folder->ISO 800”, which represents the filters that have been chosen, and also the order in which those filters have been chosen or applied. The particular items in the chain might be “active”, in the sense that clicking a given item in the chain (such as “New York folder”) might reveal a drop-down menu that suggests other possible filters with which the selected filter could be replaced, or might provide a box into which the user can type his or her own filter, or might allow the user to delete the filter. When a filter is replaced, the remaining filters may remain intact in their original position—e.g., replacing “New York folder” with “vacation” in the above example results in a chain of “Pictures->vacation->ISO 800”. It is noted that, in some system that show this type of chain, each item in the chain would have to be the name of a folder. Some such systems might also remove all subsequent items if an earlier item in the chain has been changed. For example, in such a system there might be a chain “A->B->C->D”, where A-D are the names of folders. If the user changes B to F, then the resulting chain would be “A->F”, with C and D having been removed because they occurred in the original chain after B. However, the subject matter described herein may allow non-folder items in the chain, and/or may allow replacement of an item at the beginning or middle of a chain without deleting subsequent items. It is noted that a system that allows replacement of an item in the chain while allowing other items in the chain to remain intact is not merely an obvious innovation over a system that eliminates those items that appear later in the chain than the replaced item. Systems that eliminate subsequent items do so based on the assumption that the subsequent items have no meaning if the earlier items are replaced, since such systems generally assume that the chain of items represents a folder hierarchy (e.g., folder D is within folder C, which is within folder B, etc.). However, a system that allows for a chain of arbitrary filters (i.e., both folder and non-folder based filters) is able to ascribe meaning to a chain in which one filter in the middle of the chain is replaced with another filter. Such a system cannot be derived from one in which the chain merely represents the hierarchy of folders in a filesystem.

Additionally, it is noted that some systems may allow users to search within a particular folder—e.g., by navigating to a folder and then entering a search criterion that applies within the folder. However, the subject matter herein is not merely an obvious variant of such systems, because such systems provide no mechanism that allows files to be found based on the arbitrary mixing of folder locations and search queries. Nor can such systems suggest additional filters that can be arbitrary combinations of folders and search queries.

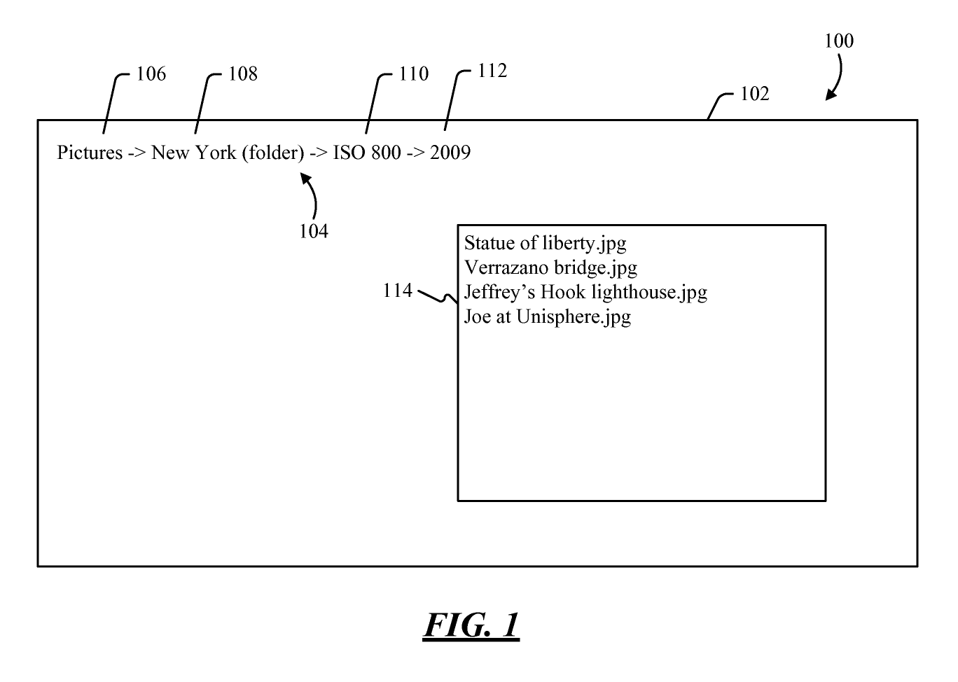

Turning now to the drawings, FIG. 1 shows an example user interface (UI) showing files that have been found using a combined search and browse experience. The example experience of FIG. 1 may be provided, for example, by a file explorer program 100. The file explorer program may display its output in window 102, although the details of the UI, and the details of how the UI is displayed, may differ depending on the device and/or environment in which the explorer program is operating. For example, on a personal computer with an operating system that provides windows as part of its UI, the file explorer program may appear in a window. However, on a particular model of smart phone and/or music player that does not provide separate windows as part of its UI, the file explorer program could appear in the entire display area of the device. The subject matter herein is not limited to any particular type of device or operating system, and may also be used in other contexts such as websites and web services.

The file explorer program 100 may display a chain 104 of filters, indicating in some order the various filters that have been specified and/or chosen by a user. In this case, chain 104 shows the filters named “Pictures” (filter 106), “New York (folder)” (filter 108), “ISO 800” (filter 110), and “2009” (filter 112). In this example, “Pictures” refers to any file that contains a photograph or image—e.g., JPEG files, files whose metadata indicates they were captured with a camera, or files satisfying any other type of criteria indicative of the file containing a photograph. “New York (folder)” refers to files that are in the folder named “New York”. “ISO 800” refers to those files whose metadata indicates that they were shot with a camera at a sensitivity level corresponding to an ISO 800 speed film. “2009” refers to files having a creation date (or access date, or modification date) in the year 2009.

Various observations can be made about filters 106-112. First, it is noted that filters can refer to a specific folder location (as in the case of filter 108, which refers to those files in the folder names “New York”), or may refer to any arbitrary criteria against which files can be searched. Second, it is noted that chain 104 records not only the set of filters that are being applied, but also records a historical order among the filters. For example, chain 104 shows that, in this example, “Pictures” was the first filter chosen, followed by “New York (folder)”, and so on. (However, as described herein, filters may be replaced, added, or deleted in the middle of a chain; after such replacement, addition, or deletion, the chain might not completely reflect the order in which the filters are chosen.) Third, it is noted that those filters that are not based on a particular folder location can be based on any type of criteria against which files can be searched. For example, “ISO 800” is a criterion that can be compared to the tag metadata in a file, and “2009” is a criterion that can be compared to the date metadata in a file. However, any arbitrary criterion could be specified—e.g., “joe smith” is an example of a text criterion, which might search for any files that satisfied the other applicable filters and that contain the words “joe” and “smith”.

Additionally, it is noted that the set of filters in chain 104 may have been selected through a user's combined action of choosing filters from a set of suggestions, and from specifying filters in “free-form.” For example, when the user initially opened file explorer program 100, the user may have been presented with several suggested criteria, of which one is “Pictures”. The user may have selected that criterion from among the choices offered. The user may then have typed the word “New York” in order to specify that he or she was looking for pictures in the “New York” folder. Since the files that survived the filters up to that point included photographs (many of which may have been tagged with ISO information), the system may have inferred that “ISO 800” was a reasonable filter to suggest, and may have shown that suggestion to the user. The user may then have chosen ISO 800 as the next filter. The user may then have typed 2009 in as an additional filter to specify that the files the user is looking for are those dated in 2009. In other words, the user may specify some filters by accepting the system's suggestion, and may specify other filters by typing an arbitrary criterion.

As a result of the filters in chain 104, a particular set 114 of files satisfying those filters is shown. As can be seen from the descriptive tiles in set 114, the files are pictures taken in New York City. Additionally, the files in set 114 are those pictures in the New York folder whose metadata (which is not shown in the drawing) also satisfies the “ISO 800” and “2009” criteria.

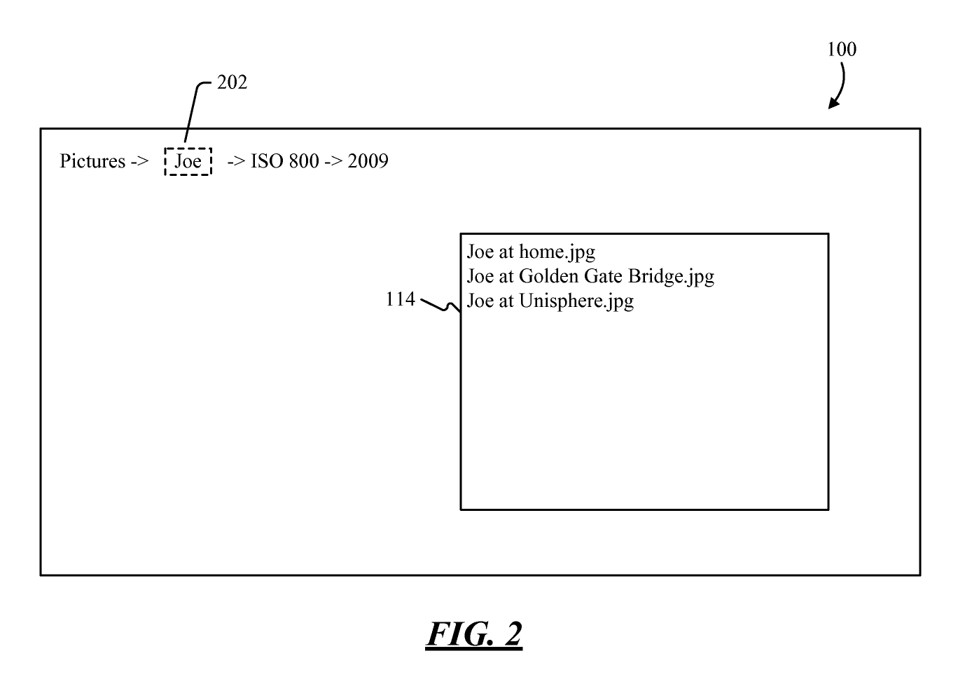

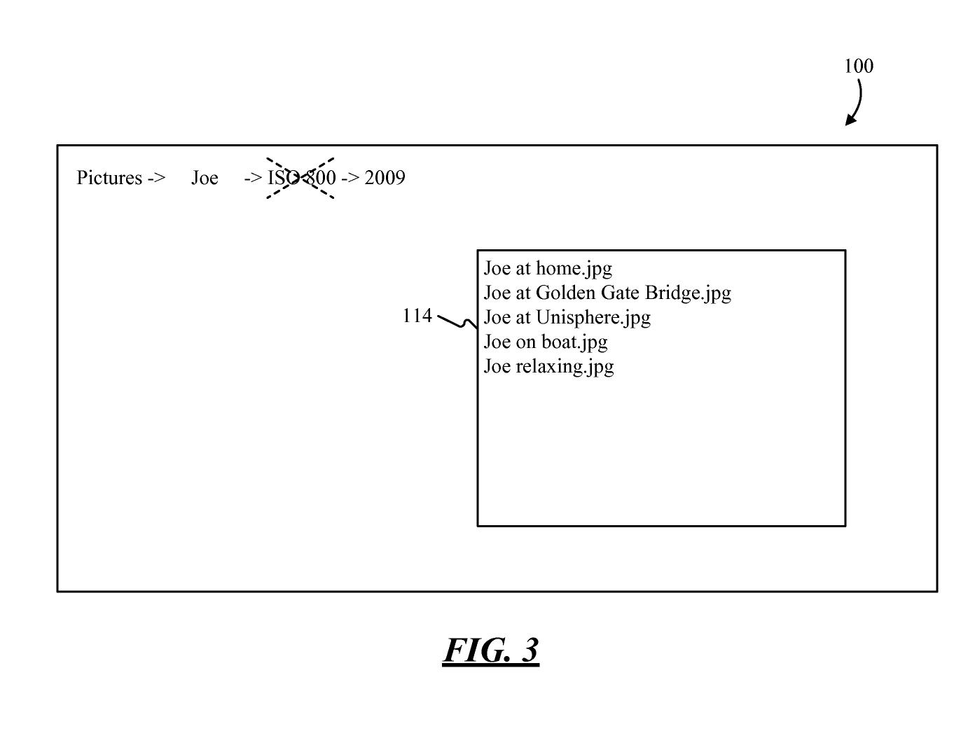

As noted above, as part of a combined search and browse experience a user may replace and/or delete filters. FIGS. 2 and 3 show examples in which filters are replaced and deleted, respectively. In FIG. 2, the file explorer program 100 of FIG. 1 is shown, but the “New York (folder)” filter of FIG. 1 has been replaced with the filter “Joe” (filter 202). For example, each of the filters listed in chain 104 (shown in FIG. 1) may be an active item that can be clicked to reveal a drop-down menu. The drop-down menu may suggest other filters that could be used to replace the clicked filter, and/or may allow the user to type his or her own filter. (The menu may also allow the user to delete a filter.)

The new filter “Joe” may refer to any file that contains the word “Joe” either within the file or in the file's title. Based on the change of filter from “New York (folder)” to “Joe”, the set 114 of files that are displayed is changed. This change may appear to the user in real time when the filter is changed. The new set 114 of files is still subject to the criteria that the files are pictures shot at ISO 800 and dated in the year 2009. However, the files are no longer subject to the criteria that they be in the folder named “New York”, but are subject to the criteria that the files contain the term “Joe” in the title or within the body of the file. Thus, as compared with FIG. 1, the files relating to the Verrazano Bridge and Jeffrey's Hook Lighthouse have disappeared (since those files appear in the “New York” folder but do not relate to Joe), and instead files relating to “Joe at Golden Gate Bridge” and “Joe at Home” have appeared (since those files relate to Joe, even though they do not necessarily appear in the New York folder).

In FIG. 3, the file explorer program 100 shows the set of filtering criteria having been modified again. In the example of FIG. 3, the criterion “ISO 800” is being deleted. With one of the criteria being deleted, the set 114 of files that satisfy the applied set of criteria may expand relative to what is shown in FIG. 2. In FIG. 3, that set expands now to include “Joe on Boat” and “Joe relaxing”. These files satisfy the remaining filters in the sense that they are picture files that mention “Joe” and that are dated 2009, but—with the constraint “ISO 800” having been removed—these new files may be pictures that were shot at different ISO.

Numerous variations on the examples of FIGS. 1-3 are possible. For example, one could add or delete additional criteria. The criteria that are added could be any kind of browse-type criteria (i.e., criteria that specify a file location or folder), or could be any kind of search-type criteria (i.e., criteria that are defined by search queries).

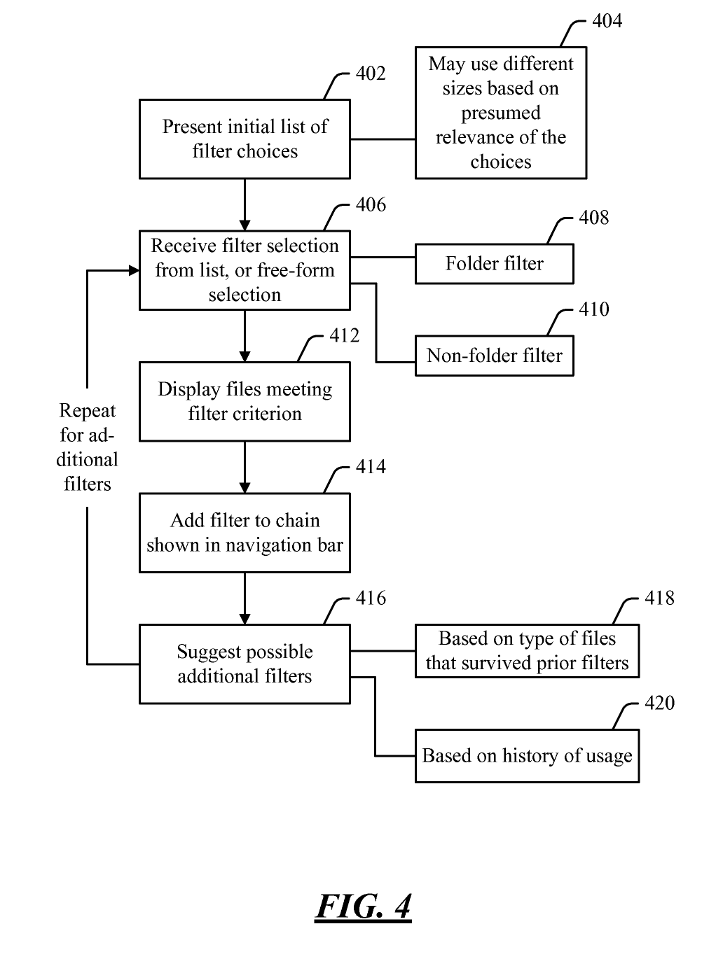

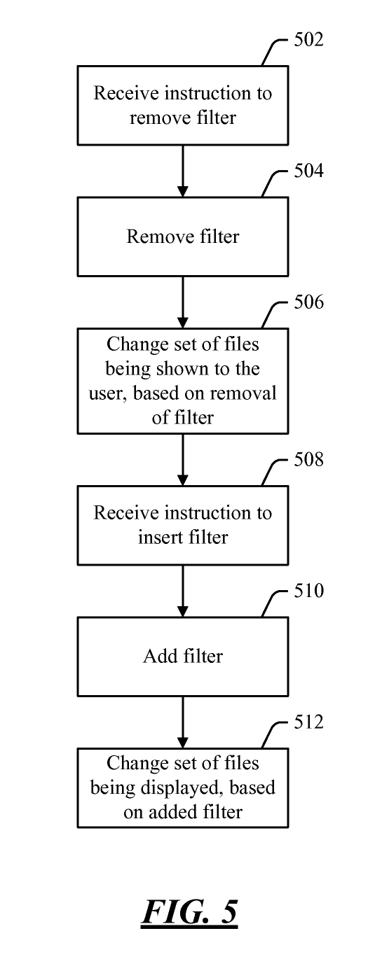

FIG. 4 shows an example process of providing a unified browse and search experience to a user. Before turning to a description of FIG. 4, it is noted that the flow diagrams contained herein (both in FIG. 4 and in FIG. 5) are described, by way of example, with reference to components shown in FIGS. 1-3, although these processes may be carried out in any system and are not limited to the scenarios shown in FIGS. 1-3. Additionally, each of the flow diagrams in FIGS. 4 and 5 shows an example in which stages of a process are carried out in a particular order, as indicated by the lines connecting the blocks, but the various stages shown in these diagrams can be performed in any order, or in any combination or sub-combination.

At 402, an initial list of filter choices may be presented to a user. For example, the system may show the user some possible filters such as “pictures”, “documents”, “mail”, “video”, or any other type of filter. The list of initial filters may be chosen to be filters that, historically, have a high likelihood of being selected by users. Or, the user may have pre-selected the initial choice of filters. In one example, the system may display previews of the filters (e.g., a few of the files that would be selected by each filter) by showing the preview results in boxes on a screen. The particular sizes of the boxes may be chosen based on the presumed relevance of each filter, and/or the historical likelihood that each filter would be chosen (block 404). For example, if users historically choose pictures more often than mail, then the “pictures” filter preview may be shown with a larger box than the “mail” filter preview.

At 406, an indication of a user's choice of a filter is received. The choice may be a selection from the list that was presented to the user, or may be a free-form entry that the user has typed. As noted above, the filter may be a folder filter (block 408), or a non-folder filter (block 410). A folder filter is one that identifies a particular folder and limits the set of files to be shown to the user based on those files' being located within a that folder—e.g., a filter that limits to all files in the “New York” folder (or in sub-folders thereof) is an example of a folder filter. A non-folder filter is one that limits the set of files to be shown to the user based on some factor other than the files' location in a folder—e.g., based on an arbitrary search criterion that takes into account a text term contained in a file or in the file's title, or the value of a piece of metadata associated with the file.

At 412, the files meeting the filter criterion are displayed. For example, each of FIGS. 1-3 shows a box that contains the set 114 of files that meet all of the filtering criteria that are currently being applied. Showing files in such a box is an example of the displaying that occurs at 412.

At 414, the filter that has been chosen (and that has been applied) may be added to the chain shown in the navigation bar. If only one filter named “A” has been applied, then that chain might read “A”. If several filters (A, B, C, and D) have already been applied and a new filter E is being added, then the chain might read “A->B->C->D->E.”

At 416, additional filters may be suggested to the user. The additional filters may be suggested based on various criteria. In one example, the filters are suggested based on the types of files that have survived prior filters (block 418). For example, if many of the files that have survived the filters that have been applied are photo files, then the filters to be suggested might be filters that relate to photos—e.g., particular ISO values, particular resolutions, particular camera names, etc. (To say that a file “survives” the filters indicates that the file has not yet been weeded out by those filters that have been applied—i.e., after all of the filters have been applied, the system is still showing the file to the user as being one of the possible files that the user is looking for.) On the other hand if the files that have survived the filter include many music files, then music-related filters could be suggested—e.g., filters based on music type (“blues”, “rock”, “alternative”, etc.), filters related to artists (“Beethoven”, “Clapton”, etc.).

In another example, the filters are suggested based on the use's history of selecting filters (block 420). For example, if the user often follows the “photos” filter by specifying an ISO value as a filter, then the system might suggest ISO values as additional filters based on the user's history of choosing this type of filter.

FIG. 5 shows an example process of removing and replacing a filter. The process of FIG. 5 may be used, for example, to perform the replacement and/or deletion of filters, as shown in FIGS. 2 and 3.

At 502, an instruction to remove a filter may be received. For example, a system may allow users to click on filter names, thereby revealing a drop-down menu that allows the user to replace or delete the clicked filter. Selecting an instruction to delete the filter from the drop-down menu is an example of the instruction that may be received at 502.

At 504, the filter indicated in the instruction is removed. For example, if the chain of currently-applied filters is “A->B->C->D”, and the instructions says to remove filter “C”, then the resulting chain of filters is “A->B->D”. At 506, the set of files that is being shown to the user may be changed based on the new set of filters. For example, if a filter has been removed, the removal of a filter may expand the universe of files that satisfies the current set of filters, so any files that are no longer being excluded by the filters may be added to the set of files being shown to the user. In other words, once a filter has been removed, the set of files that is shown to the user can now be determined without regard to whether the files satisfy the filter that has been removed. (FIG. 3, as discussed above, shows an example of how files are added to the set of files being shown to the user due to the removal of a filter.)

At 508, an instruction to insert a filter may be received. The instruction may simply add a filter to the existing set of filter, or the instruction may replace an existing filter with a new filter (e.g., by clicking on an existing filter, and selecting a new filter from a drop-down menu). At 510, the new filter is added. For example, if the set of filters had been “A->B->C”, then replacement of the “B” filter with a “D” filter may result in the filters being “A->D->C”. This is an example of inserting filter “D” between “A” and “C” (following removal of filter “B”). Or, in another example, a filter may be added to the end of the existing chain of filter—e.g., “A->B->C” may become “A->B->C->D”. At 512, the set of files being displayed may be changed based on the added filter. For example, adding a new filter may shrink the set of files being shown to the user. Or, replacing an existing filter with a new filter may change the set of files that are being shown to the user by adding some files and removing other files.

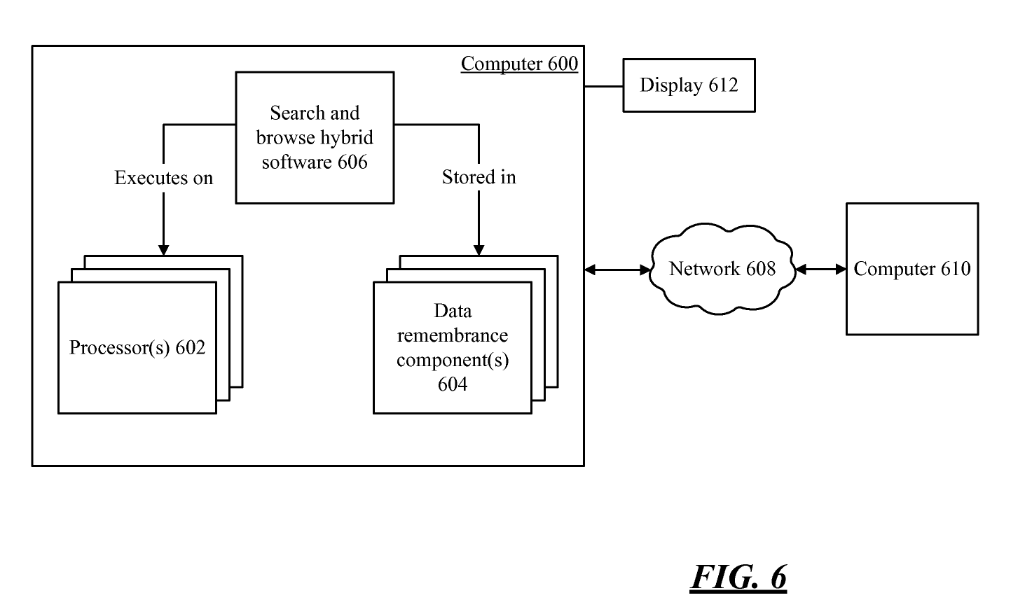

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 612, which may be a cathode ray tube (CRT) monitor, a liquid crystal display (LCD) monitor, or any other type of monitor.

Software may be stored in the data remembrance component(s) 604, and may execute on the one or more processor(s) 602. An example of such software is search and browse hybrid software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium. It is noted that there is a distinction between media on which signals are “stored” (which may be referred to as “storage media”), and—in contradistinction—media that transmit propagating signals. DVDs, flash memory, magnetic disks, etc., are examples of storage media. On the other hand, wires or fibers on which signals exist ephemerally are examples of transitory signal media.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 600 may be communicatively connected to one or more other devices through network 608. Computer 610, which may be similar in structure to computer 600, is an example of a device that can be connected to computer 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage devices that store executable instructions for finding files, wherein the executable instructions, when executed on a computer, cause the computer to perform acts comprising:
receiving an indication of a first filter;
displaying files that satisfy said first filter;
displaying a navigation bar that shows said first filter;
receiving an indication of a second filter, one of said first filter and said second filter identifying a folder, the other one of said first filter and said second filter being a non-folder criterion;
displaying files that satisfy both said first filter and said second filter; and
adding said second filter to a position in said navigation bar that shows that said second filter was applied after said first filter.

2. The one or more computer-readable storage devices of claim 1, wherein said acts further comprise:
suggesting a set of third filters based on said first filter and on said second filter.

3. The one or more computer-readable storage devices of claim 2, wherein said suggesting of said set of third filters is further based on an analysis of which files have survived said first filter and said second filter.

4. The one or more computer-readable storage devices of claim 2, wherein said suggesting of said set of third filters is further based on an analysis of locations of files that have survived said first filter and said second filter.

5. The one or more computer-readable storage devices of claim 1, wherein said navigation bar shows said first filter, said second filter, and a third filter in an order that shows that said third filter was added after said second filter and said second filter was added after said first filter, and wherein said acts further comprise:
receiving an instruction to remove said second filter from said navigation bar;
removing said second filter so that said navigation bar shows said first filter and said third filter; and
displaying files that satisfy said first filter and said third filter without regard to whether the files satisfy said second filter.

6. The one or more computer-readable storage devices of claim 1, wherein said acts further comprise:
suggesting a set of third filters based on what filters a user has used in the past.

7. The one or more computer-readable storage devices of claim 1, wherein said acts further comprise:
presenting a set of filter choices to a user before any filter has been selected, said first filter being selected by said user from said filter choices.

8. The one or more computer-readable storage devices of claim 1, wherein said acts further comprise:
receiving an indication that a user has selected a filter in said navigation bar; and
displaying a drop-down menu from the selected filter, wherein said drop-down menu contains a set of suggested filters with which to replace the selected filter, and an option to delete the selected filter.

9. A method for finding files, the method comprising:
using a processor to perform acts comprising:
receiving an indication of a first filter;
displaying, in a window of a program, files that satisfy said first filter;
displaying, in said window, a navigation bar that shows said first filter;
receiving an indication of a second filter, one of said first filter and said second filter identifying a folder, the other one of said first filter and said second filter being a non-folder criterion;
displaying, in said window, files that satisfy both said first filter and said second filter; and
adding said second filter to a position in said navigation bar that shows that said second filter was applied after said first filter.

10. The method of claim 9, wherein said acts further comprise:
suggesting a set of third filters based on said first filter and on said second filter based on either:
an analysis of which files have survived said first filter and said second filter; or
locations of files that have survived said first filter and said second filter.

11. The method of claim 9, wherein said navigation bar shows said first filter, said second filter, and a third filter in an order that shows that said third filter was added after said second filter and said second filter was added after said first filter, and wherein said acts further comprise:
receiving an instruction to remove said second filter from said navigation bar;
removing said second filter so that said navigation bar shows said first filter and said third filter; and
displaying files that satisfy said first filter and said third filter without regard to whether the files satisfy said second filter.

12. The method of claim 9, wherein said acts further comprise:
receiving an indication that a user has selected a filter in said navigation bar;
displaying a drop-down menu from the selected filter, wherein said drop-down menu contains a set of suggested filters with which to replace the selected filter, and an option to delete the selected filter.

13. A system for finding files, the system comprising:
a memory;
a processor; and
a component that is stored in said memory and that executes on said processor, said component receiving an indication of a first filter, said component displaying files that satisfy said first filter, said component displaying said first filter in a navigation bar, said component receiving an indication of a second filter, wherein one of said first filter and said second filter identifies a folder and the other one of said first filter and said second filter is a non-folder criterion, said component displaying files that satisfy both said first filter and said second filter, and said component adding said second filter to a position in said navigation bar that shows that said second filter was applied after said first filter.

14. The system of claim 13, wherein said component suggests a set of third filters based on said first filter and on said second filter.

15. The system of claim 14, wherein said component suggests said set of third filters based on an analysis of which files have survived said first filter and said second filter.

16. The system of claim 14, wherein said component suggests said set of third filters based on an analysis of locations of files that have survived said first filter and said second filter.

17. The system of claim 13, wherein said navigation bar shows said first filter, said second filter, and a third filter in an order that shows that said third filter was added after said second filter and said second filter was added after said first filter, and wherein said component receives an instruction to remove said second filter from said navigation bar, removes said second filter so that said navigation bar shows said first filter and said third filter, and displays files that satisfy said first filter and said third filter without regard to whether the files satisfy said second filter.

18. The system of claim 13, wherein said component suggest a set of third filters based on what filters a user has used in the past.

19. The system of claim 13, wherein said component presents a set of filter choices to a user before any filter has been selected, said first filter being selected by said user from said filter choices.

20. The system of claim 13, wherein said component receives an indication that a user has selected a filter in said navigation bar, and displays a drop-down menu from the selected filter, wherein said drop-down menu contains a set of suggested filters with which to replace the selected filter, and an option to delete the selected filter.
